(19) United States
(12) Patent Application Publication
(10) Pub. No.: US 2012/0024389 A1
(43) Pub. Date: Feb. 2, 2012

(54) INTEGRATED ELECTROMAGNETIC ACTUATOR, IN PARTICULAR ELECTROMAGNETIC MICRO-PUMP FOR A MICROFLUIDIC DEVICE BASED ON MEMS TECHNOLOGY, AND MANUFACTURING PROCESS

(75) Inventors: Lucio Renna, Catania (IT); Clelia Galati, San Gregorio di Catania (IT); Natalia Maria Rita Spinella, Agrate Brianza (IT); Piero Giorgio Fallica, Catania (IT)

(73) Assignee: STMicroelectronics S.r.l., Agrate Brianza (IT)

(21) Appl. No.: 13/194,583

(22) Filed: Jul. 29, 2011

(30) Foreign Application Priority Data
Jul. 30, 2010 (IT) TO2010A000664

(51) Int. Cl. F15D 1/00; H01F 7/06; B01L 3/00; H01F 41/06

(52) U.S. Cl. 137/1; 29/605; 335/219; 422/505

(57) ABSTRACT

An integrated electromagnetic actuator comprising: a first structural layer; a flexible membrane, extending over the first structural layer and comprising regions of ferromagnetic material; a chamber, delimited between the first structural layer and the flexible membrane; a winding, comprising a plurality of turns of conductive material and extending within the first structural layer; and a core element made of ferromagnetic material, extending within the first structural layer, inside the winding.

### BACKGROUND

1. Technical Field

The present disclosure regards an integrated electromagnetic actuator, a microfluidic device that uses the actuator, a process for manufacturing the actuator and the microfluidic device, and a method for displacing liquid using the actuator.

2. Description of the Related Art

Known to the art are micropumps for generating a flow of a fluid in a given direction in a channel of a microfluidic device. The micropumps generally comprise a membrane of flexible material, arranged above a portion of the channel, actuated in compression through a piezoelectric actuator. When the piezoelectric actuator causes a deflection of the membrane towards the channel, the fluid present in the channel is moved within the channel itself, for example from a hole for inlet into the channel to a hole for outlet from the channel. However, since the deflection of the membrane caused by a piezoelectric actuator is generally limited in amplitude (given that the displacement of the piezoelectric actuator itself is limited), the piezoelectric actuators are generally driven at a high frequency of vibration, which involves a high consumption of electrical energy. In addition, the piezoelectric actuator is made of generally costly materials, which causes an increase in the manufacturing costs.

In order to overcome the aforementioned problems, micropumps with electromagnetic actuation have been proposed, for example in U.S. Application Publication No. 2010/0111726. Said micropumps comprise a substrate 1, a top plate 2, a deformable membrane 3 comprising a magnetic material, and a planar winding 4. The substrate 1 comprises, on a first face, a groove 5, above which the top plate 2 is mounted. The top plate 2 is provided with an inlet hole 6, an outlet hole 7, and a through hole 8, formed between the inlet hole 6 and the outlet hole 7, and in communication, when top plate 2 is mounted on the substrate, with the groove 5. The membrane 3 is arranged on the through hole 8, in such a way as to close the latter, thus forming a reservoir 9. The winding 4 is arranged facing a face of the substrate 1 opposite to the face on which the top plate 2 is mounted, in such a way as to be aligned with the reservoir 9. In use, the winding 4 is traversed by electric current and, as is known, generates a magnetic field, the direction of which depends upon the direction of flow of the current. Since the membrane 3 comprises magnetic material, for magnetic fields of sufficiently high intensity, the membrane 3 can be controlled in deflection so as to approach the substrate 1 or recede therefrom by simply varying the direction of flow of the current in the winding 4. When the membrane 3 is deflected in such a way that it moves away from the substrate 1, a negative pressure is created within the reservoir 9, which causes a movement of the fluid from the inlet hole 6 towards the reservoir 9, which fills. When the membrane 3 is deflected in such a way that it approaches the substrate 1, the fluid within the reservoir 9 is compressed and made to come out from the reservoir 9. To favor outlet of the fluid in the direction of the outlet hole 7 rather than in the direction of the inlet hole 6 (in this way generating an effective flow of the fluid in a preferential direction), the micropump described operates according to the principle of an impedance pump. In detail, the distance between the inlet hole 6 and the reservoir 9, through the groove 5, is greater than the distance between the reservoir 9 and the outlet hole 7.

When the membrane 3 oscillates (or vibrates) under the force impressed by the magnetic field generated by the winding 4, a non-uniform distribution of pressure is generated on the fluid, which is pushed prevalently towards the outlet hole 7. However, the flow rate that is obtained markedly depends upon the frequency of vibration of the membrane 3, rendering this micropump subject to pressure problems as the frequency of vibration of the membrane 3 varies, and difficult to modulate.

In addition, the need to form a reservoir 9 in a pre-defined position with respect to the inlet hole 6 and outlet hole 7 in order to guarantee a non-uniform distribution of pressure on the fluid to be moved renders this micropump not practical for being integrated in systems of a “lab-on-chip” type.

### BRIEF SUMMARY

Some embodiments of the present disclosure are an integrated electromagnetic actuator, a microfluidic device that uses the actuator, a process for manufacturing the actuator and the microfluidic device, and a method for displacing liquid using the actuator that will be free from the disadvantages of the known art.

According to the present disclosure, an integrated electromagnetic actuator, a microfluidic device that uses the actuator, a process for manufacturing the actuator and the microfluidic device, and a method for displacing liquid using the actuator are provided as defined, respectively, in claims 1, 12, 15, and 24.

In particular, the actuator comprises: a chamber; a flexible membrane, comprising a region of ferromagnetic material extending above the chamber; a winding; and a core element extending inside the winding. In use, the winding and the core element co-operate in such a way that, when the winding is traversed by a current, a magnetic field is generated with a direction and intensity such as to cause a deflection of the membrane towards the bottom surface of the chamber.

### BRIEF DESCRIPTION OF THE SEVERAL VIEWS OF THE DRAWINGS

For a better understanding of the present disclosure, preferred embodiments thereof are now described, purely by way of non-limiting example, with reference to the attached drawings, wherein:

FIG. 1 shows, in cross-sectional view, a micropump with electromagnetic actuation of a known type;

FIG. 2 shows, in cross-sectional view, an electromagnetic actuator according to one embodiment of the present disclosure;

FIGS. 3a-3c show, in top plan view, windings belonging to the actuator of FIG. 2, according to respective embodiments;

FIG. 4 shows, in perspective view, the electromagnetic actuator of FIG. 2;

FIGS. 5a-5g show an operating sequence of a plurality of actuators of FIGS. 2 and 4, which operate according to the principle of a three-phase peristaltic pump;

FIG. 6 shows in perspective view a portion of the electromagnetic actuator of FIGS. 2 and 4;

FIGS. 7-13 show, in cross-sectional view, manufacturing steps for the production of the electromagnetic actuator of FIG. 2;

FIG. 14 shows, in perspective view, a microfluidic diagnostic device that integrates an electromagnetic actuator according to one embodiment of the present disclosure;

FIG. 15 shows a block diagram of a device for controlled release of drugs that integrates an electromagnetic actuator according to one embodiment of the present disclosure; and

FIG. 16 shows, in cross-sectional view, an electromagnetic actuator according to a further embodiment of the present disclosure.

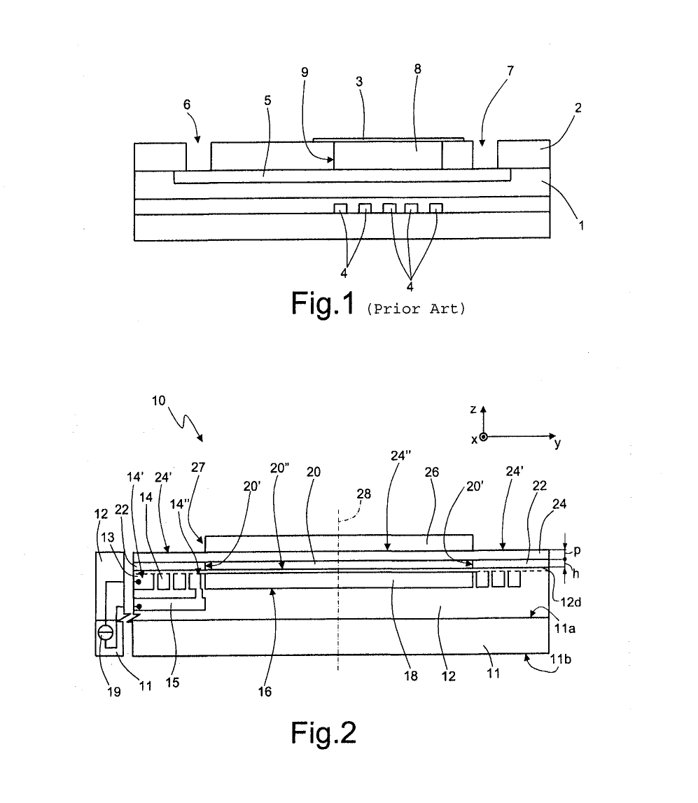

### DETAILED DESCRIPTION

FIG. 2 shows, in lateral cross-sectional view, an actuator 10 of an electromagnetic type according to an embodiment of the present disclosure. In particular, the actuator 10 is a magnetic or electromagnetic actuator. More in particular, the actuator 10 is a micropump configured for being integrated in microfluidic devices.

The actuator 10 comprises a substrate 11, made, for example, of semiconductor material, more in particular silicon. Alternatively, the substrate 11 may be made of plastic material. According to an embodiment of the present disclosure, the substrate 11 can be of a pre-processed type and have, in a way known and not shown in the figure, one or more overlapping regions of semiconductor and/or dielectric and/or metal material.

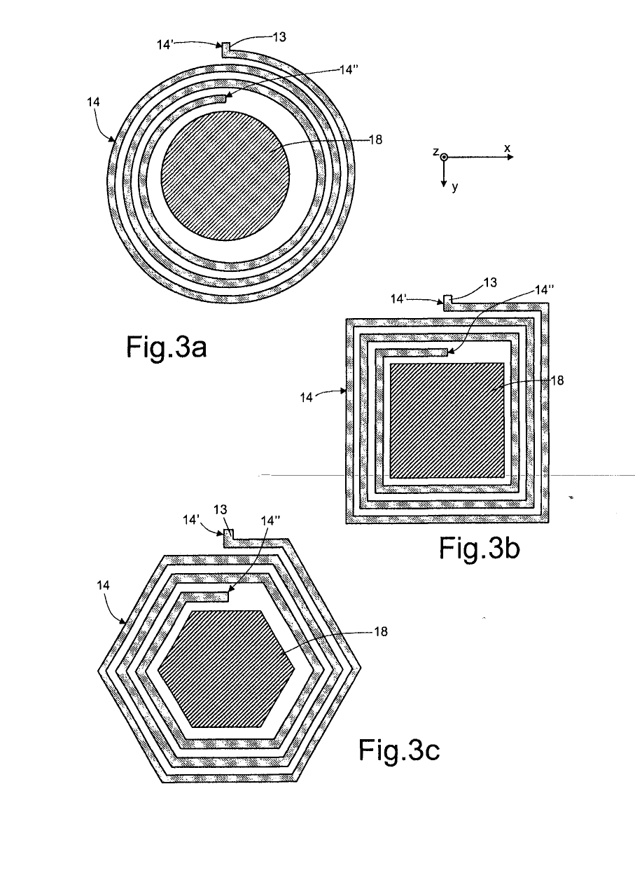

Extending on a face 11a of the substrate 11 is a first structural layer 12, for example made of silicon oxide, arranged in direct contact with the substrate 11 through the face 11a. Formed within the first structural layer 12 is a winding 14, or inductor, obtained using MEMS technology. The winding 14 comprises a plurality of concentric and coplanar turns, and is completely integrated within the first structural layer 12. Each turn of the plurality of turns is made of conductive material and has, in top plan view, a circular shape (FIG. 3a) or a quadrangular shape (FIG. 3b), or a generally polygonal shape (FIG. 3c), or any other shape. The winding 14 is made of conductive material, in particular metal, such as, for example, aluminum, gold, nickel, or an alloy thereof, or any other metal. According to the dimensions and the degree of integration that it is desirable to obtain, the winding 14 can be formed by a number of turns ranging between 1 and 1000, for a total length, in extension, of between 100 μm and 100 m. Each turn is laterally separated from the other turns of the winding 14 by a distance of between 100 nm and 100 μm. Each turn moreover has a width of between 100 nm and 100 μm, and a thickness of between 10 nm and 100 μm. It is evident that the dimensions indicated above for the winding 14 are examples of possible embodiments of the winding 14. According to further embodiments of the present disclosure, the winding 14 can have dimensions different from the ones indicated, greater or smaller, and/or a number of turns greater than 1000.

In order to enable electrical contact of both of the terminals 14′, 14″ of the winding 14, a first conductive path 13 and a second conductive path 15 are provided, formed in metal layers different from one another. The first conductive path 13 is in electrical contact with a first terminal portion 14′ of the winding 14 belonging to the outermost turn of the winding 14; the second conductive path 15 is, instead, in electrical contact with a second terminal portion 14″ of the winding 14, belonging to the innermost turn of the winding 14. The second conductive path 15 is formed in a metal layer different from the metal layer in which the turns and the first conductive path 13 are formed, in particular in a lower metal layer.

The first and second conductive paths 13, 15 are connected to biasing means 19, in particular a current generator, preferably of a type integrated in the substrate 11. The current generator 19 is configured to generate a flow of current between the first terminal portion 14′ and the second terminal portion 14″ of the winding 14. In addition, by alternating the direction of flow of the current within the winding 14, the direction of the magnetic field generated is altered accordingly.

The turns of the winding 14 define a region 16 internal to the winding 14, in which a core element 18 is arranged, for example made of iron, or cobalt, or nickel, or a mixture thereof, or, in general, any ferromagnetic material. The core element 18 extends completely within the first structural layer 12. Present above the first structural layer 12 is a chamber or channel, designated by the reference number 20, laterally delimited by a second structural layer 22, which is arranged on top of and in direct contact with the first structural layer 12 and which defines side walls 20′ of the channel 20. The second structural layer 22 is made, for example, of photoresist. A photoresist that can be used has a base of acrylic polymers, which possess good characteristics of adhesion and strength. Alternatively, the second structural layer 22 is made of the same material as the first structural layer 12, in particular silicon oxide. The second structural layer 22 has a thickness h of between 1 μm and 500 μm, for example 20 μm.

The channel 20 is moreover delimited at the bottom by the first structural layer 12, which defines a bottom 20″ of the channel 20.

The channel 20 is separated from the winding 14 by a portion 12d of the first structural layer 12 having a thickness of between 1 nm and 100 μm, preferably 10 nm.

Arranged above the second structural layer 22 is a cover layer 24, in direct contact with the second structural layer 22 so as to seal the channel 20 hermetically at the top. The cover layer 24 is, for example, an adhesive tape or an adhesive film, or again a layer of material rendered adhesive and coupled to the second structural layer 22 so as to seal the channel 20. More in particular, the cover layer 24 is made of a transparent polymeric material, preferably bio-compatible, for example chosen in the group comprising polyethylene, glass, Plexiglas, polycarbonate, polydimethylsiloxane (PDMS), or the like. Again, the cover layer 24 is made of a generic elastomeric material or material with elastomeric base, such as, for example, polyurethane.

The cover layer 24 has a thickness p preferably of between 1 μm and 100 μm, for example 10 μm.

Arranged on top of the cover layer 24 is a passive element 26, for example made of ferromagnetic material such as iron, or nickel, or cobalt, or a mixture thereof, or any other material with ferromagnetic properties. The passive element 26 is coupled to the cover layer 24 in such a way that the movement of the passive element 26 along an axis 28 substantially perpendicular to the cover layer 24 causes a consequent movement of the cover layer 24 along the axis 28.

The cover layer 24 and the passive element 26 form a membrane layer 27.

The substrate 11 further comprises, in a way not shown in FIG. 2, electronic devices designed to supply a current i within the turns of the winding 14. As is known, the flow of current i in the winding 14 generates a magnetic field defined by a magnetic-field vector having direction and sense that depend upon the direction and sense of the current i (according to the known “right-hand rule”).

In the case where the passive element 26 has an own intense magnetic field, for example in the case where the passive element 26 is made of a ferromagnetic material previously magnetized having high value of coercivity and saturation, by alternating the sense of the flow of current within the winding 14, it is possible to generate a magnetic field with alternating sense that causes the action of respective forces, with senses opposite to one another, on the passive element 26. These forces are such as to act on the passive element 26 in the direction defined by the axis 28, parallel to the axis Z and substantially orthogonal to the plane XY in which the cover layer 24 lies, in order to displace the cover layer 24 in both senses of the axis 28.

The cover layer 24, in its movement along the axis 28, has degrees of freedom limited by the fact that it is coupled to the second structural layer 22 along peripheral portions 24′ of the cover layer 24. Hence, just a central portion 24″ of the cover layer 24 oscillates along the axis 28, approaching and moving away from the bottom 20″ of the channel 20 according to the corresponding movement of the passive element 26.

The winding 14, the core element 18, and the passive element 26 form an electromagnetic-actuator element configured for generating, when a current is made to flow in the winding 14 such as to induce a magnetic field, a controlled deformation, or a vibration, of the cover layer 24.

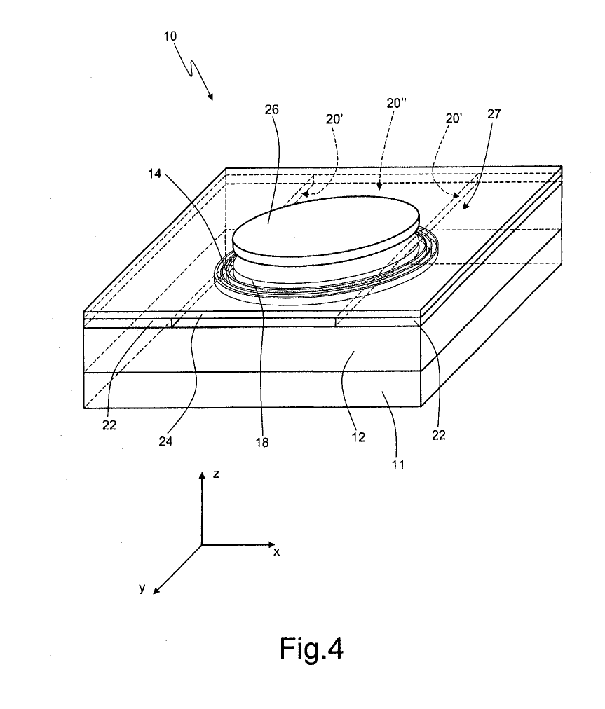

FIG. 4 shows, in perspective view, the actuator 10 described with reference to FIG. 2.

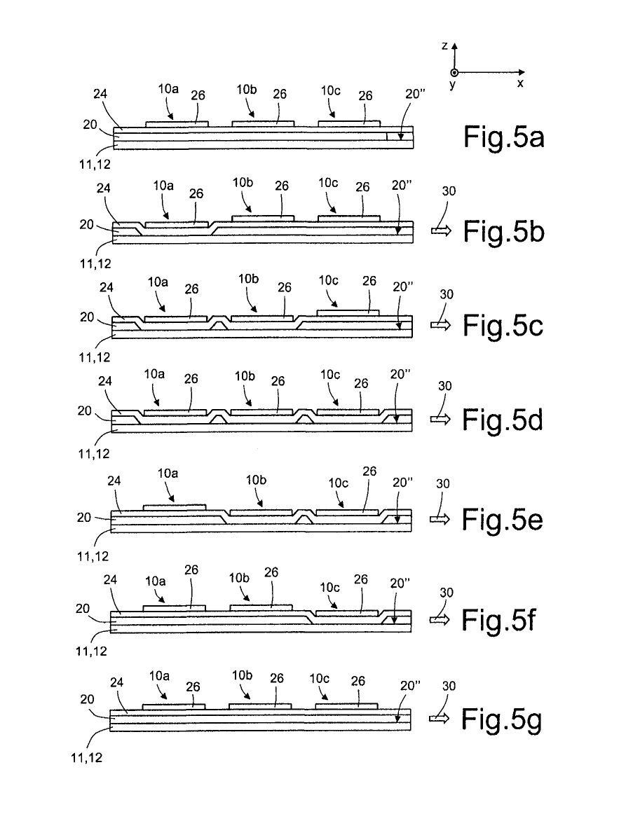

In use, in order to guarantee a flow of a fluid present in the channel 20 with a preset direction and sense, it is possible to provide a plurality of micropumps 10 along one and the same channel 20 and operate the micropumps 10 as shown in FIGS. 5a-5g, which show the principle of operation of a three-phase peristaltic pump.

In detail, FIGS. 5a-5g show, in schematic form, a method for operating a plurality of actuators 10; in particular, three actuators 10 are shown, arranged in sequence along a common channel 20. In this case, each actuator 10 operates as a micropump. For clarity of description, in what follows designated by 10a is the actuator 10 appearing on the left in the representation of FIGS. 5a-5g; designated by 10c is the actuator 10 appearing on the right in the representation of FIGS. 5a-5g; and designated by 10b is the actuator 10 appearing at the center in the representation of FIGS. 5a-5g, between the actuator 10a and the actuator 10c.

FIG. 5a shows a starting step in which the micropumps 10a-10c are in a resting state, and no current flows in the respective windings 14.

Then (FIG. 5b), current is made to flow in the winding 14 of the actuator 10a so as to generate a magnetic field that causes on the passive element 26 of the actuator 10a the action of a force directed towards the channel 20. Consequently, the cover layer 24 of the actuator 10a goes down, under the force of the field generated and acting on the passive element 26, until it comes into contact with the bottom 20″ of the channel 20. There is hence a first displacement of the fluid within the channel 20.

Next (FIG. 5c), while maintaining the cover layer 24 of the actuator 10a lowered, in contact with the bottom 20″ of the channel 20, current is made to flow in the winding 14 of the actuator 10b so as to generate a magnetic field that causes on the passive element 26 of the actuator 10b the action of a force directed towards the channel 20. Consequently, the cover layer 24 of the actuator 10b goes down, until it comes into contact with the bottom 20″ of the channel 20. There is in this case a second displacement of fluid within the channel 20, with orientation defined by the arrow 30 in FIG. 5c. In fact, since the channel 20 is closed by the action of the actuator 10a, the only sense of flow possible for the fluid is the one defined by the arrow 30.

Then (FIG. 5d), while maintaining the cover layer 24 of the actuator 10b lowered, in contact with the bottom 20″ of the channel 20, current is made to flow in the winding 14 of the actuator 10c so as to generate a magnetic field that causes on the passive element 26 of the actuator 10c the action of a force directed towards the channel 20. There is also in this case a further displacement of fluid within the channel 20, with orientation defined by the arrow 30.

As shown in the subsequent FIGS. 5e-5g, the coating layers 24 of the actuators 10a-10c are then brought into a position at a distance from the bottom 20″ of the channel 20. By performing this operation in sequence, i.e., bringing in sequence the actuator 10a, then the actuator 10b, and finally the actuator 10c into a position at a distance from the bottom 20″ of the channel 20, the portion of channel 20, in the region corresponding to the actuators 10a-10c, is filled with fluid coming from the region appearing to the left of the micropumps 10a-10c. An effective flow of fluid is thus obtained, with orientation defined by the arrow 30, all along the channel 20.

To bring each actuator 10 back into a resting position it is typically sufficient to interrupt the flow of current in the respective winding 14. However, in order to prevent any possible problem of stiction of the cover layer 24 to the bottom 20″ of the channel 20, it is possible to favor recession of the cover layer 24 from the bottom 20″ of the channel 20 by generating a magnetic field such as to guide the passive element (and hence the cover layer 24) in the direction defined by the axis Z so that it recedes from the channel 20. The magnetic field is generated by causing a current to flow in the winding 14 with sense opposite to that of the current used for attracting the passive element 26 (and hence the cover layer 24) towards the channel 20. This phenomenon is possible thanks to the high residual magnetization that exists in the majority of ferromagnetic materials and can be controlled by choosing as ferromagnetic material of the passive element 26 a material with a coercivity value higher than the respective coercivity value of the core element 18. In this way, for an appropriate value of the magnetic field in the winding 14, after reversal of the direction of flow of the current, the magnetic field is found in opposition with respect to the residual magnetic field of the passive element 26, thus generating a repulsive force.

The principle of operation of the actuator 10 described takes into account a plurality of physical phenomena. It is known that the magnetic field orthogonal to the plane in which the winding 14 lies, in the center of the winding 14 and assuming a winding 14 with circular turns, is given by the summation of the contributions of each turn of the winding 14. As is known, a detailed analysis of the lines of magnetic field, generated by a winding traversed by current, in planes parallel to the plane in which the turn lies and arranged at various distances 6 from the plane in which the turn lies, shows that the magnetic field is not uniform. The non-uniformity is verified also in different points of one and the same plane. It is likewise known that for values of δ<<R (where R is the radius of the innermost turn of the winding 14), the magnetic field can be considered, to a first approximation, uniform in the entire cylindrical volume having a height equal to δ and a base width defined by the innermost turn of the winding 14.

The force used to deform the cover layer 24 can be calculated if the shear modulus of the material that forms the cover layer 24 is known. The force of magnetic attraction exerted on the passive element 26 can be derived from the analysis of the energy of magnetic field present in the area between the core element 18 and the passive element 26. If the thickness of the portion of the first structural layer 12 that separates the channel from the winding 14 and from the core element 18 is neglected, the thickness g of the area is given by g≈h+p. The presence of the core element 18 arranged inside the winding 14 produces, as is known, a gain of the magnetic field (the gain has a variable value, according to the ferromagnetic material used to form the core element 18, approximately between 10² and 10⁶). For values of g<<R it is possible to consider the magnetic field in the region between the core element 18 and the passive element 26 as a uniform field.

Given hereinafter is a numeric example of the magnetic force exerted on a passive element 26 by a winding 14 provided with a core element 18, and forming an actuator 10 according to the present disclosure.

Consider a winding 14 comprising 50 metal turns, in which the innermost turn has a radius R₁=250 μm and the outermost turn has a radius R₅₀=400 μm. The conductive wire with which the winding 14 is made is an aluminum wire (more in detail, an aluminum planar conductive path) having a width of 1.5 μm and a thickness of 1.5 μm. The turns are laterally separated from one another by 1.5 μm. The current i that flows through the winding 14 has a value of approximately 13 mA. It is to be noted that the current is maintained at a low value for reasons of maximum safety in so far as, for nanometric or micrometric dimensions of the turns (height and width), a higher value of current (for example by one or more orders of magnitude) could cause burning of the winding 14.

The core element 18 is made of ferromagnetic material and has a value of magnetic-permeability constant μₘ=10³.

In addition, the thickness of the cover layer is assumed as being p=10 μm and the value of the shear modulus of the cover layer 24 is assumed as being 0.0086 GPa (a polyurethane cover layer 24 is considered in this example). The depth of the channel 20 is assumed as being h=10 μm, and the maximum angle of deformation of the cover layer 24 to come into contact with the bottom 20″ of the channel 20 is 45°.

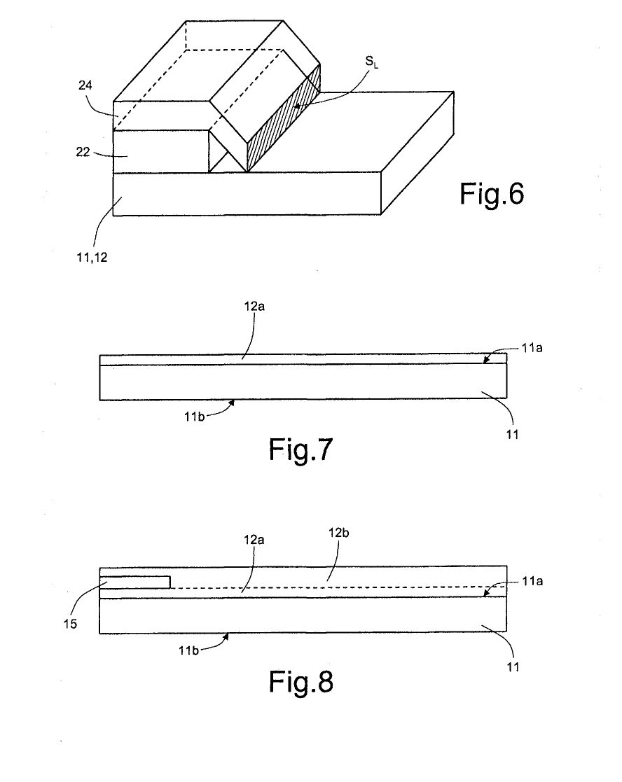

The minimum force F_{M} that must be applied to deform the cover layer 24 can be calculated on the basis of the following formula (1):

$$\frac{{F}_{M}}{{S}_{L}} = G \cdot tg ( ϑ ) \qquad ( 1 )$$

where: S_{L} is the area of a lateral surface of the sectioned cover layer 24 (shown hatched in FIG. 6); G is the shear modulus of the cover layer 24; and θ is the angle of deformation of the cover layer 24.

Hence, considering a cover layer having a thickness of 10 μm and a diameter of 500 μm, the value of S_{L} is given by 2π·500·10=15700 μm². There is hence obtained a value of force F_{M} necessary for deformation of the cover layer 24 of approximately 0.13 Pa.

The value of magnetic field Bₜₒₜ generated by the winding 14, for all the turns of the latter, is given by the following formula (2):

$${B}_{tot} = {\sum }_{n = 1}^{50} \frac{{μ}_{0} i}{2 R} {μ}_{m} \qquad ( 2 )$$

where we have considered: a winding having 50 turns; a value of current i of 13 mA; turns set at the same distance apart having a minimum radius (innermost turn) R₁=250 μm and a maximum radius (outermost turn) R₅₀=400 μm; a value of air magnetic permeability μ₀=4π·10⁻⁷; and a value of magnetic permeability of the core element 18 μₘ=10³.

There is thus obtained a value of Bₜₒₜ of approximately 1.31 T.

Given the value of Bₜₒₜ calculated according to Eq. (2), the force of attraction F_{A} generated on the cover layer 24 by the passive element 26 is given by the following formula (3):

$${F}_{A} = \frac{d U}{d g} = \frac{{B}^{2} A}{2 {μ}_{0}} \qquad ( 3 )$$

where U is the magnetic energy contained in the volume defined between the core element 18 and the passive element 26, given by the following formula (4):

$$U = \frac{1}{2 {μ}_{0}} {B}^{2} gA \qquad ( 4 )$$

where g is the distance that separates the core element 18 from the passive element 26, substantially given by the thickness of the cover layer (p) added to the value of depth of the channel 20 (h); and A is the area of the core element 18, assumed equal to the area of the passive element 26 (with reference to the values previously indicated, A=π·R₁²=π·250²=196250 μm²).

On the basis of the values previously indicated by way of example, a value of force of attraction F_{A}=0.13 N is obtained.

The value of F_{A} is hence such as to deflect, in use, the cover layer 24 considered.

By modifying as desired the values of electric current i, of thickness h of the channel 20, of thickness p of the cover layer 24, the material of which the core element 18 and the passive element 26 are made (hence varying their value of magnetic permeability μₘ), the number and size of the turns of the winding 14, and in general the other parameters involved in the formulas given above, it is possible to vary the value of force applied to the cover layer 24, consequently varying the characteristics of compression and displacement of the fluid present, in use, in the channel 20.

An estimate of the flow of fluid obtained by applying a value of force F_{D} as indicated previously can be obtained assuming that, at each pumping cycle, the fluid present in the portion of channel substantially underneath the passive element 26 is completely moved in the same direction, in particular in the direction in which it is desired to obtain the flow of fluid (for example as indicated by the arrow 30 in FIGS. 5b-5g). Using a pumping-cycle frequency of 10 Hz, a flow of fluid (in this case the fluid is assumed to be water) of 0.8 μL/min is obtained.

It is here pointed out that the value of flow can be easily altered (increased or decreased) by simply varying the value R of the radius of the turns of the winding 14. In particular, by reducing the value of R the value of the flow is reduced, which is useful in applications that require extremely low rates of flow.

It is evident that what has just been described merely exemplifies operation of the actuator 10. A variation of the pumping characteristics can be obtained by varying other parameters with respect to the ones indicated, or the geometry of the various components of the actuator 10. For example, it is possible to use turns 4 having a square shape, which best fit the geometry of a rectangular channel.

FIGS. 7-13 show successive steps of a process for manufacturing the actuator 10. FIGS. 7-13 do not show process steps for manufacturing the current generator 19, which is provided in a form integrated in the substrate 11 in a known way.

As shown in FIG. 7, a substrate 11 is provided, for example made of semiconductor material, preferably silicon, or, alternatively, plastic material. The substrate 7 comprises the current generator 19 (here not shown). Then, on the front side 11a of the substrate 11, opposite to the back side 11b of the substrate 11, a first intermediate layer 12a is formed, for example made of thermally grown or deposited silicon oxide.

Next (FIG. 8), formed on the first intermediate layer 12a, for example via known deposition techniques, is a layer of conductor material, which is then shaped, via known lithographic and etching techniques in such a way as to form a conductive path 15 extending towards a peripheral region of the substrate 11. As already described with reference to FIG. 2, the conductive path 15 has, in use, the function of forming an electrical connection between the innermost turn of the winding 14 (not yet formed in the process step of FIG. 8) and biasing means external to the winding 14 (here not shown). The conductive path 15 may be made of metal, for example aluminum. Alternatively, the conductive path 15 may be made of doped polysilicon.

Then, a second intermediate layer 12b is formed on the conductive path 15 and on the first intermediate layer 12a. Following upon formation of the second intermediate layer 12b, the latter, if necessary, is planarized. The second intermediate layer 12b is preferably made of the same material as the first intermediate layer 12a, in the example described silicon oxide.

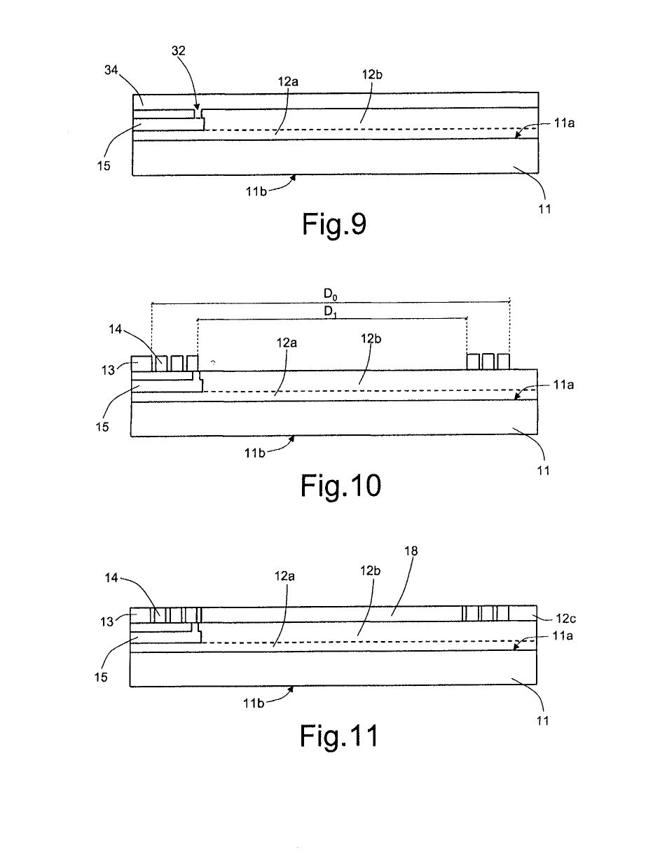

Next (FIG. 9), via successive lithographic and etching steps, a contact hole 32 is opened through the second intermediate layer 12b, until the conductive path 15 is reached. Then a step of formation of a layer of conductive material 34 is carried out on the second intermediate layer 12b and within the contact hole 32, thus forming a conductive path between the conductive path 15 and the layer of conductive material 34.

Then (FIG. 10), via successive lithographic and etching steps, the layer of conductive material 34 is shaped in such a way as to form the winding 14, comprising a plurality of concentric turns. The innermost turn of the winding 14 is in contact, via a terminal portion of its own, with the contact hole 32 and, via the latter, with the conductive path 15.

According to an embodiment of the present disclosure, the winding 14 has, in top plan view, a circular shape. The innermost turn has, for example, a diameter D_{I} of between 10 μm and 5000 μm, preferably 500 μm, whilst the outermost turn has a diameter D_{O} of between 20 μm and 20000 μm, preferably 1600 μm.

According to a further embodiment of the present disclosure, the winding 14 has, in top plan view, a square shape. In this case, D_{I} is the length of the side of the innermost square, whilst D_{O} is the length of the side of the outermost square.

Each turn of the winding 14 has a width of between 0.1 μm and 100 μm, preferably 1 μm. In addition, the turns are spaced from one another by a distance of between 0.1 μm and 100 μm, preferably 1 μm.

Then (FIG. 11), formed on the second intermediate layer 12b is a third intermediate layer 12c. The third intermediate layer 12c fills the space between the turns of the winding 14 and is made of dielectric material. For example, the third layer 12c is made of deposited silicon oxide. Following upon formation of the third intermediate layer, the latter is removed in an area corresponding to a region internally defined by the winding 14, until the surface of the second intermediate layer 12b is exposed. A layer of ferromagnetic material (for example iron, or nickel, or cobalt, or a mixture thereof) is then formed such as to cover the exposed surface of the second intermediate layer 12b so as to form the core element 18. The core element 18 has a thickness approximately equal to the thickness of the turns of the winding 14, for example between 0.01 μm and 100 μm, preferably 1 μm. Any ferromagnetic material that may be present on the third intermediate layer 12c following upon the step of formation of the core element 18 is removed.

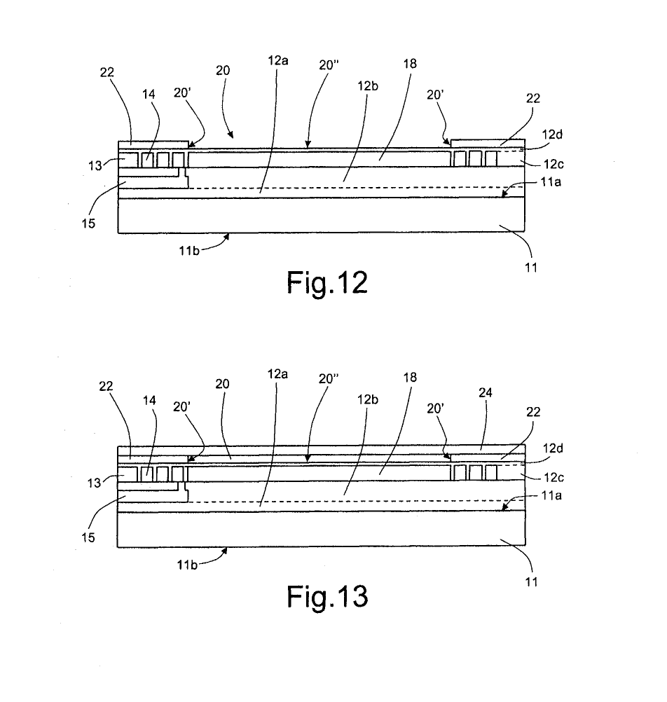

Next (FIG. 12), formed on the core element 18 of the third intermediate layer 12c and of the winding 14 is a fourth intermediate layer 12d, made of dielectric material, for example silicon oxide. The fourth intermediate layer 12d has a thickness of between 1 nm and 100 μm, preferably 10 nm.

It is clear that, since the fourth intermediate layer 12d forms, at the end of the manufacturing steps, the bottom 20″ of the channel 20, the fourth intermediate layer 12d can be made, for reasons that depend upon the particular application of the actuator 10, of materials different from silicon oxide. For example, it may be made of deposited polymeric layers, transparent plastic substrates, or oxynitride, or may be passivated after its formation.

The first 12a, second 12b, third 12c, and fourth 12d intermediate layers form the first structural layer 12 of FIG. 2.

Then, formed on the fourth intermediate layer 12d is a second structural layer 22, for example made of deposited SiO₂, or dry photoresist formed by means of lamination. Alternatively, the second structural layer 22 can be formed by spinning of photoresist of a liquid type. Then a photolithographic process is carried out to define a channel 20 within the second structural layer 22. For this purpose, a mask (not shown), defining (in a positive or negative way, according to the photoresist used) the channel 20, is used for the photolithographic step. A subsequent etching step enables selective removal of portions of the second structural layer 22 until the fourth intermediate layer 12d is exposed, thus forming the channel 20 delimited laterally by the second structural layer 22 and at the bottom by the fourth intermediate layer 12d.

The channel 20 is formed substantially in an area corresponding to the core element 18. For this purpose, alignment marks, of a known type, can be provided.

Finally (FIG. 13), a cover layer 24 is set above the channel 20, in contact with the second structural layer 22. The cover layer 24 is, for example, as has been said, an adhesive tape or film, of compatible transparent polymeric material. The cover layer 24 may even be a suspended membrane of silicon oxide or of silicon with a thickness sufficiently small as to deflect or deform, for example with a thickness of between 3 nm and 70 nm. It is evident that the smaller the angle required for deformation, the greater may be the thickness of the cover layer 24.

Formed on the cover layer 24, through sputtering techniques or screen printing or ink jet printing, is the passive element 26, made of ferromagnetic material, for example iron, or nickel, or cobalt, or a mixture thereof. The passive element 26 is formed substantially in a position corresponding to the core element 18 and vertically aligned therewith. For this purpose, alignment marks (not shown) may be envisaged, so as to enable alignment of the passive element 26 with the core element 18. The actuator 10 of FIG. 2 is thus obtained.

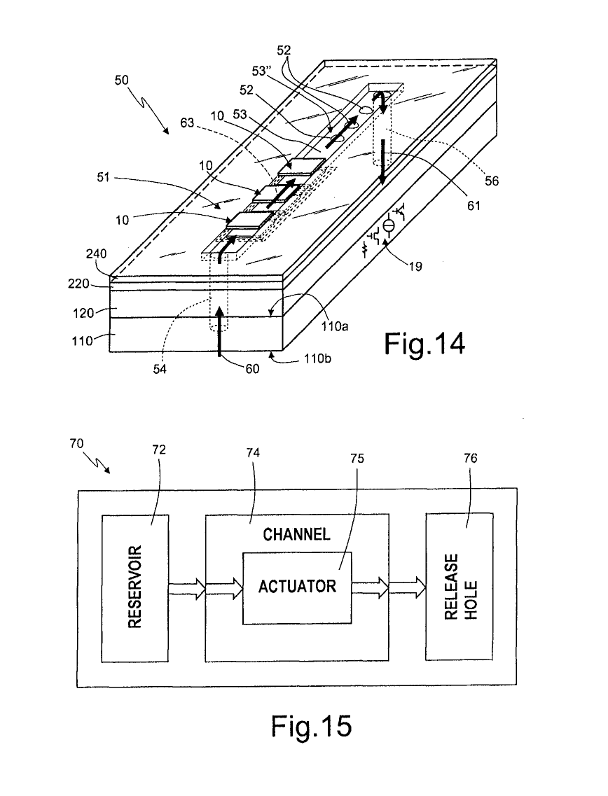

FIG. 14 shows a perspective view of an integrated device 50, in particular a diagnostic device, comprising a fluid displacing device 51 including a plurality of actuators 10 of the type previously described. In particular, the fluid displacing device 51 comprises three actuators 10, which operate as described and shown with reference to FIGS. 5a-5g. According to the embodiment shown in FIG. 14, the winding 14, the core element 18, and the passive element of the actuators 10 have a square shape.

The diagnostic device 50 comprises a substrate 110 (common to all the actuators 10, similar to the substrate 11) and a first structural layer 120 (which is also common to the actuators 10 and is similar to the first structural layer 12), arranged on top of, and in direct contact with, the substrate 110. The substrate 110 comprises integrated electronic components (shown schematically), in particular designed to form the current generator 19.

Extending over the first structural layer 120 is the second structural layer 220 (which is also common to all the actuators 10 and which is similar to the second structural layer 22), in which a channel 53 in fluid communication with each respective channel 20 of each actuator 10 is provided.

The first structural layer 120, in particular in a position corresponding to the bottom 53″ of the channel 53, is, in this case, made of a material compatible with the use of the diagnostic device 50, for example biocompatible material (e.g., silicon oxide). Alternatively, a non-biocompatible layer may be used, passivated in an area corresponding to the bottom 53″ of the channel 53. Common passivation materials include silanes, albumin, sonicated salmon-sperm DNA, random hexamer oligonucleodites, and the like. In addition, in some applications, it may be desired to functionalize one or more surfaces for immobilizing receptors, for example adding hydroxyl (OH) groups. All these surfaces are referred to as “compatible”, where by this term is meant that the surface is compatible with the assay and with the receptors used in the device.

The thickness of the substrate 110 is variable and chosen so as to guarantee at the same time ease of production of the diagnostic device 50 and of the integrated actuators 10 and also resistance to impact of the diagnostic device 50 and of the actuators 10.

The second structural layer 220 has, according to a further embodiment not shown in the figure, a plurality of channels similar to the channel 53. In the case where a plurality of channels 53 is present, each channel 53 is isolated from other channels 53 by means of the second structural layer 220.

The channel 53 shown in FIG. 14 has a rectangular shape, in top plan view, and is isolated on all four sides by the second structural layer 220. Other shapes, different from the rectangular shape, are possible, for example once again shaped like a circular, square, or in general polygonal serpentine, for example with or without rounded corners. In the case of a number channels 53 on one and the same diagnostic device 50, each channel 53 can in any case have a shape and size different from the shape and size of the other channels 53, chosen in the design stage according to the need.

The channel 53 houses one or more detection regions 52 (for example in the form of “spots” housed in series along the channel 53 and separated from one another by approximately 100 μm), comprising receptor biomolecules deposited in a known way. For example, it is possible to use an automated spotting technique, which substantially envisages the use of a mechanical arm, which, in an automatic way, takes samples of the biological material to be deposited (in liquid solution) and, with micrometric precision, deposits drops of the biological material in the channel 53 to form the detection regions 52.

Typically, each of the drops is of a few picoliters, but the drops can be as large as 1-5 μl, or larger still, according to the application and to the available size of the specimen. Alternatively, the entire surface of a certain region can be covered if desired for the application considered.

In addition, the diagnostic device 50 comprises an inlet hole 54 and an outlet hole 56, formed through the substrate 110 and the first structural layer 120 and designed to form, respectively, an access path (see the arrow 60) from the outside of the diagnostic device 50 towards the channel 53 and an outlet path (see the arrow 61) from the channel 53 towards the outside of the diagnostic device 50.

The diagnostic device 50 further comprises a cover layer 240, which covers the channel 53 and forms, at the same time, the cover layer 24 of the actuators 10. The cover layer 240 has hence characteristics similar to those described with reference to the cover layer 24.

The cover layer 240 is arranged on top of, and in contact with, the second structural layer 220, and has the function both of supporting the passive element 26 of each actuator 10 and of hermetically sealing the channel 53 at the top. In this way, the single points for access to the channel 53 are the inlet hole 54 and the outlet hole 56. The cover layer 240 is, for example, made of elastomeric material, in particular transparent to light. In the case where the channel 53 is transparent to light, it is altogether optically accessible from the outside of the diagnostic device 50, which can be used in fluorescence systems or for visual inspection. In general, it is important for the step of coating of the channel 53 not to damage the receptors or the material deposited in the channel 53, and hence processes that envisage, for example, thermal treatments at high temperature or using plasma would have to be excluded in the case of heat-sensitive molecules.

The inlet and outlet holes 54, 56 can be provided with a respective closing element (not shown), for example a plug made of plastic or elastomeric material, which seals the channel 53. The inlet and outlet holes 54, 56 may also be provided with a fast-coupling system for fluidic connections, of a known type, for example of a threaded type or a clamp type.

The detection regions 52 comprise, for example, a given type of receptors, such as biomolecules (DNA, RNA, proteins, antigens, antibodies, etc.) or micro-organisms or parts of them (bacteria, viruses, spores, cells, organelles, etc.) or any chemical element used for detecting an analyte. The receptors, provided with specific markers, for example fluorescent markers, are immobilized on the bottom 53″ of the channel 53. According to alternative embodiments, the receptors can be free in solution instead of being immobilized to the device, according to the application for which the diagnostic device 50 is used. However, solid-phase assays are generally preferred since they enable washing away of non-immobilized material and hence increase the sensitivity and simplicity of the detection assays.

When these receptors are set in direct contact with a biological specimen to be analyzed comprising molecules capable of combining with the receptors, the combination of the molecules with the receptors activates specific markers, for example fluorescent markers. When the fluorescent markers are activated, they can emit autonomously a light radiation. Alternatively, the fluorescent markers can be induced into a state of light emission by external excitation. Only the activated markers are able to emit light radiation of their own, whereas non-activated markers do not respond to the external excitation (or in any case, in general, do not emit light radiation or emit light at a different wavelength).

By operating the actuators 10 according to the steps described with reference to FIGS. 5a-5g, the biological liquid or the specimen is made to flow from the inlet hole 54 (see the arrow 60) along the entire channel 53 (see the arrow 63). In this way, the biological liquid comes into contact with the detection regions 52 and then comes out of the channel 53 through the outlet hole 56 (see the arrow 61).

Detection of the fluorescence can be carried out with the channel 53 emptied, not emptied, or only partially emptied, as desired for the specific application.

The manufacturing steps of the diagnostic device 50 correspond to the manufacturing steps of the actuator 10, shown and described with reference to FIGS. 7-13. However, in order to form the inlet and outlet holes 54, 56 and the detection regions 52, further process steps are envisaged.

In detail, the inlet hole 54 and outlet hole 56 are formed, for example, after the steps described with reference to FIG. 12. For this purpose, on the back side 110b of the substrate 110 a mask is formed, designed to define regions in which the inlet hole 54 and outlet hole 56 are to be formed.

Next, by means of successive etching steps, the portions of the substrate 110 left exposed by the mask are removed, until the first structural layer 120 is reached. Then, by means of a subsequent etching, portions of the first structural layer 120 are removed until the channel 53 is reached. In the case where the first structural layer 120 is made entirely of silicon oxide, just one etch is sufficient to reach the channel 53. Alternatively, in the case where the structural layer 120 comprises different materials overlapping on one another, a number of etching steps may be necessary, each of them selective for the type of material to be removed. In addition, the etch can be either of a dry type or of a wet type, as desired.

The back side 110b of the substrate 110 is thus set in fluid communication with the channel 53 to form the inlet hole 54 and the outlet hole 56.

In the case of a substrate 110 made of silicon and a first structural layer 120 made of silicon oxide, the etching operation for formation of the inlet holes 54 and outlet holes 56 can be plasma etching using alternatively SF₆, CF₄ or a combination of SF₆ and C₄F₈. The step of formation of the holes is preferably compatible with TSV (through silicon via) technology, which enables removal, in a single etching step, of both portions of the substrate 11 and portions of the first structural layer 120.

To form the detection regions 52, following upon formation of the inlet and outlet holes 54, 56, cleaning of the bottom 53″ of the channel 53 is carried out, for example using a piranha solution, i.e., a mixture of sulphuric acid H₂SO₄ and hydrogen peroxide H₂O₂, or, alternatively, an RCA-1 cleaning (sometimes called standard clean SC-1), i.e., a mixture of H₂O, NH₄OH, H₂O₂, which can be followed by a further cleaning with a second cleaning using a mixture of H₂O₂, HCl and H₂O. There is then carried out a step of cleaning and activation (for example, to expose OH groups) of the bottom 53″ of the channel 53, by means of a mixture of HCl and CH₃OH, and then a step of functionalization of the bottom 53″ of the channel 53 is carried out (for example, by means of silanization). The detection regions 52 are then formed, for example using an automated-spotting technique. Since the bottom 53″ of the channel 53 is completely accessible at the top, the spotting step does not involve complex processes of alignment. Since this step is of a known type, it is not described any further herein.

In this way, the diagnostic device 50 of FIG. 14 is formed.

According to a further use of the present disclosure, one or more actuators 10 can be integrated in a device for controlled release of drugs 70 (shown in schematic form in FIG. 15). The device for controlled release of drugs 70 comprises a reservoir 72 designed to contain a drug, in liquid solution, which is to be administered to a patient. The reservoir 72 is connected to a release hole 76 of the device 70, through which the drug is released in the area to be treated. The path of the drug from the reservoir 72 to the release hole 76 occurs through a channel 74 provided with a device for movement of fluid 75, in particular comprising one or more actuators 10 of the type described with reference to FIG. 2, which operate as micropumps according to the steps described with reference to FIGS. 5a-5g (of the type already shown and described with reference to the diagnostic device 50 of FIG. 14).

By appropriately configuring the dimensions of the channels 20, 74 (which are in fluid connection with one another) and/or the force of compression exerted by each actuator 10 on the liquid present, in use, in the channel 20, it is possible to regulate as required the amount of drug released through the release hole 76.

The process for manufacturing the actuator 10, described with reference to FIGS. 7-13, and/or the diagnostic device 50, and/or the device for controlled release of drugs 70, can be implemented at an industrial level by working an entire wafer of semiconductor material, provided on which are a plurality of actuators 10 and/or diagnostic devices 50 and/or devices for controlled release of drugs 70 of the type described previously. In this case, at the end of the manufacturing steps, the wafer is diced into single chips, and the chips are packaged.

From an examination of the characteristics of the disclosure provided according to the present disclosure the advantages that it affords emerge clearly.

The integrated actuator according to the present disclosure enables management of extremely small flows of liquids.

In addition, for manufacturing simplicity, the actuator according to the present disclosure is extremely advantageous from an economic point of view, rendering it suitable for devices of a disposable type.

In addition, thanks to the high level of integration and to the use of biocompatible materials, the actuator described can be used in micro-devices that can be implanted for biomedical applications, also in implantable devices.

Finally, the use of a core element 18 arranged inside and planar to the winding 14, enables generation of intense magnetic fields also in the case of low currents applied to the winding 14. This enables at the same time a considerable energy saving, a reduced heating of the winding 14 by the Joule effect, and a considerable saving in terms of area occupation. In fact, the present applicant has verified that, given the same intensity of magnetic field generated, the solution that envisages a winding 14 provided with a core element 18 according to the present disclosure is of a size considerably smaller than that of a winding 14 without the core element 18.

Finally, it is clear that modifications and variations may be made to the disclosure described and illustrated herein, without thereby departing from the sphere of protection thereof.

For example, the passive element 26 can be set underneath the cover layer 24 and fixed with respect thereto. Alternatively, the cover layer 24 itself can comprise ferromagnetic material. In this latter case, the cover layer 24 and the passive element 26 coincide.

In addition, the turns of the winding 14 and the core element 18 may not be coplanar but be arranged on different planes (i.e., be provided on different metal layers).

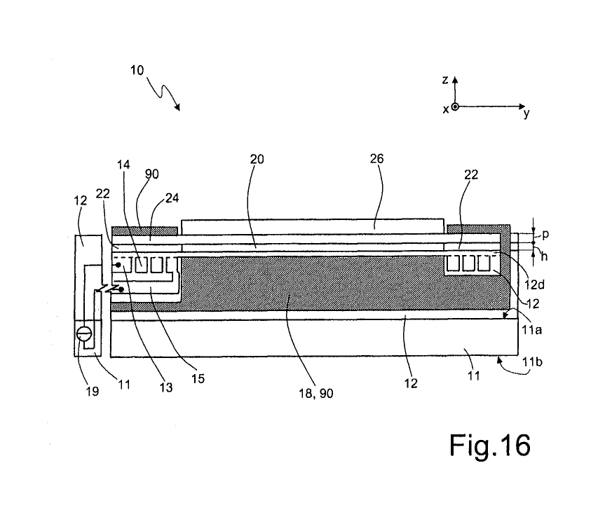

In addition, as shown in FIG. 16, a shell 90 of ferromagnetic material can be provided (for example, made of the same material as the core element 18) surrounding the winding 14 on all or on some of its sides, within the first structural layer 12 and/or above the cover layer 24, laterally with respect to the passive element 26. The core element 18 extends within the first structural layer 12 until it comes into contact with the shell 90. The winding 14 is in any case electrically insulated from the shell 90 by portions of the first structural layer 12 between the shell 90 and the winding 14. This embodiment presents the advantage of increasing the value of the magnetic field applied to the passive element 26, given the same conditions, as compared to the embodiment of FIG. 2.

Finally, the actuator described according to the present disclosure can be used for applications other than those of a micropump. For instance, it can be used, when necessary, for narrowing a channel thus reducing the amount of fluid that flows in the channel and at the same time increasing the pressure thereof locally. In addition, the actuator according to the present disclosure can be used as micro-valve, to interrupt and alternatively enable a flow of a liquid in a channel.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An integrated electromagnetic actuator comprising:
a first structural layer;
a flexible membrane extending over the first structural layer and including ferromagnetic regions;
a chamber delimited between the first structural layer and the flexible membrane;
a conductive winding, including a plurality of turns, extending within the first structural layer; and
a ferromagnetic core element extending within the first structural layer, inside the winding.

2. The actuator according to claim 1, further comprising a substrate having a first face and a second face opposite to one another, the first structural layer being formed on the first face of the substrate.

3. The actuator according to claim 2, wherein the winding comprises a pair of ends, the actuator further comprising a current generator integrated in the substrate and electrically coupled to the ends of the winding.

4. The actuator according to claim 1, wherein the turns of the winding and the core element are coplanar.

5. The actuator according to claim 1, wherein the membrane comprises a cover layer and a passive element made of ferromagnetic material, fixed with respect to the cover layer, the actuator further comprising a second structural layer extending between the first structural layer and the flexible membrane and laterally delimiting the chamber.

6. The actuator according to claim 5, wherein the core element, the chamber, and the passive element extend longitudinally in respective parallel planes and are substantially vertically aligned with each other.

7. The actuator according to claim 5, wherein the cover layer is made of a material of the group consisting of: an elastomer, a plastic material, photoresist, semiconductor material, silicon oxide, silicon.

8. The actuator according to claim 5, wherein the core element and the passive element are made of a material chosen from amongst: nickel, cobalt, iron, or a mixture thereof.

9. The actuator according to claim 5, wherein the chamber has a shape in the group consisting of a quadrangular shape, a circular shape, a polygonal shape, and a polygonal shape with rounded corners and extends throughout a thickness of the second structural layer.

10. The actuator according to claim 1, wherein the chamber has a depth of between 1 μm and 1000 μm, preferably 10 μm.

11. The actuator according to claim 1, wherein said substrate is made of semiconductor material and the first structural layer is made of dielectric material.

12. A microfluidic device comprising:
an inlet hole;
an outlet hole;
a channel, forming a fluidic path with the inlet hole and the outlet hole; and
a first micropump arranged on the fluidic path and having a first electromagnetic actuator that includes:
a first structural layer;
a first flexible membrane extending over the first structural layer and including ferromagnetic regions;
a chamber delimited between the first structural layer and the first flexible membrane;
a first conductive winding, including a plurality of turns, extending within the first structural layer; and
a first ferromagnetic core element extending within the first structural layer, inside the first conductive winding.

13. The device according to claim 12, wherein said channel houses at least one detection region that includes probe molecules fixed to the first structural layer, inside the channel and, configured to detect respective target molecules.

14. The device according to claim 12, comprising a multi-phase peristaltic pump that includes the first micropump, a second micropump, and a third micropump, each of the second and third micropumps including a second electromagnetic actuator that includes:
a second flexible membrane extending over a portion of the first structural layer and including ferromagnetic regions, a portion of the chamber being delimited between the portion of the first structural layer and the second flexible membrane;
a second conductive winding, including a plurality of turns, extending within the first structural layer; and
a second ferromagnetic core element extending within the first structural layer, inside the second conductive winding.

15. The device according to claim 12, wherein the first flexible membrane comprises a cover layer and a passive element made of ferromagnetic material, fixed with respect to the cover layer, the actuator further comprising a second structural layer extending between the first structural layer and the first flexible membrane and laterally delimiting the chamber.

16. A process, comprising:
manufacturing an electromagnetic actuator, of the manufacturing including:
forming a first structural layer;
forming a flexible membrane that includes ferromagnetic regions over the first structural layer;
forming a chamber between the first structural layer and the flexible membrane;
forming a winding, having a plurality of turns of conductive material, within the first structural layer; and
forming a core element, made of ferromagnetic material, within the winding.

17. The process according to claim 16, further comprising:
providing a substrate having a first face and a second face opposite to one another, wherein:
forming the first structural layer includes forming the first structural layer on the first face of the substrate.

18. The process according to claim 16, wherein forming the winding and the core element further comprise forming the winding and the core element coplanar with one another.

19. The process according to claim 16, wherein forming the membrane layer comprises:
forming a second structural layer on top of the first structural layer;
forming a cover layer on top of and in contact with the second structural layer; and
forming a passive element, of ferromagnetic material, fixed with respect to the cover layer.

20. The process according to claim 19, wherein forming the core element, the chamber, and the passive element comprise forming the core element, the chamber, and the passive element substantially vertically aligned and extending longitudinally in respective planes parallel with respect to one another.

21. The process according to claim 19, wherein forming the cover layer comprises providing a material chosen in the group consisting of: an elastomer, a plastic material, a resist, a semiconductor material, silicon oxide, and silicon.

22. The process according to claim 19, wherein forming the core element and the passive element comprises depositing a material chosen from amongst: nickel, cobalt, iron, or a mixture thereof.

23. The process according to claim 16, wherein forming the winding comprises forming a pair of ends at opposite terminals of the winding, the method further comprising forming a current generator integrated in the substrate and electrically coupled to the ends of the winding.

24. The process according to claim 16, wherein forming the first structural layer comprises thermally growing and/or depositing silicon oxide.

25. A method, comprising:
displacing a liquid in an integrated device that includes an inlet hole, an outlet hole, a channel that forms a fluidic path with the inlet hole and the outlet hole, and a first micropump arranged on the fluidic path and having a first electromagnetic actuator that includes a first structural layer, a first flexible membrane extending over the first structural layer and including ferromagnetic regions, a first chamber delimited between the first structural layer and the first flexible membrane, a first conductive winding, including a plurality of turns, extending within the first structural layer, and a first ferromagnetic core element extending within the first structural layer, inside the first conductive winding, wherein displacing the liquid includes:
supplying a current to the winding;
generating a magnetic field traversing the core element; and
deforming the flexible membrane towards the first structural layer.

26. The method according to claim 25, wherein deforming comprises fluidically isolating two portions of the chamber (20) from one another by bringing the flexible membrane into contact with the first structural layer.

27. The method according to claim 25, wherein the first micropump includes a first portion of the chamber, the integrated device comprises a second micropump and a third micropump formed respectively including second and third portions of the chamber, the method including sequentially closing the portions of the chamber by sequentially controlling said first, second, and third micropumps.
